(19) United States
(12) Patent Application Publication
(10) Pub. No.: US 2021/0398745 A1
(43) Pub. Date: Dec. 23, 2021

(54) DEVICE FOR MANUFACTURING SOFT MAGNETIC MATERIAL USING ULTRASONIC VIBRATION, MANUFACTURING METHOD THEREOF, AND SOFT MAGNETIC MATERIAL MANUFACTURED USING THE SAME

(71) Applicant: KOREA INSTITUTE OF INDUSTRIAL TECHNOLOGY, Cheonan-si, Chungcheongnam-do (KR)

(72) Inventors: Hyun Rok CHA, Gwangju (KR); Myeong Hwan HWANG, Gwangju (KR); Jong Ho HAN, Gwangju (KR); Dong Hyun KIM, Gwangju (KR); Gye Seong LEE, Gwangju (KR)

(73) Assignee: KOREA INSTITUTE OF INDUSTRIAL TECHNOLOGY, Cheonan-si, Chungcheongnam-do (KR)

(21) Appl. No.: 17/292,280

(22) PCT Filed: Nov. 25, 2019
(86) PCT No.: PCT/KR2019/016278

§ 371 Date: May 7, 2021

(30) Foreign Application Priority Data
Nov. 23, 2018 (KR) 10-2018-0146560

(51) Int. Cl. H01F 41/02; H01F 1/12; B22F 3/03; B22F 3/093

(52) U.S. Cl. CPC H01F 41/0246; B22F 3/093; B22F 3/03; H01F 1/12

(57) ABSTRACT

The present invention relates to an apparatus and a method for manufacturing a soft magnetic composite using ultrasonic vibration and a soft magnetic composite manufactured using the ultrasonic vibration. More specifically, the present invention relates to the apparatus for manufacturing a soft magnetic composite using ultrasonic vibration including: a die that has a putting-in space as an open space in which a powder material is put; a punch set that is inserted into the putting-in space and presses the powder material; an ultrasonic vibration applying unit including ultrasonic vibrators which are arranged along a circumference of an outer die surface of the die and are provided to come into contact with the die; a main body that is positioned below the die and is formed to slide around the die toward an outer circumference; and a control unit that controls a frequency of the ultrasonic vibrators depending on a degree of pressure of the punch set, a method for manufacturing a soft magnetic composite using ultrasonic vibration, and a soft magnetic composite manufactured using the same.

### TECHNICAL FIELD

The present invention relates to an apparatus and a method for manufacturing a soft magnetic composite using ultrasonic vibration and a soft magnetic composite manufactured using the ultrasonic vibration, and more specifically, to an apparatus and a method for manufacturing a soft magnetic composite using ultrasonic vibration and a soft magnetic composite manufactured using the same in order to increase density and improve performance of the soft magnetic composite which is manufactured by pressing powder.

### BACKGROUND ART

As hybrid or electric cars use an electric motor, a demand for an electric motor producing higher output power is gradually increased for good ride quality, and the electric motor also tends to gradually increase in weight. In this respect, many companies invest heavily in development of electric motors which can produce high output power and also be lightweight.

A soft magnetic composite (SMC) is widely used as a stator used in the electric motors.

The SMC broadly has the following three characteristics. Firstly, the SMC is made of ferromagnetic iron powder particles. Secondly, the particles are surrounded with an electromagnetic coating layer. Thirdly, the SMC is used by being compacted through pressure compaction.

The SMC can not only decrease an adverse effect of eddy current, but also can have a significant increase in effect, compared to conventional common iron powder. In addition, the SMC has an advantage in that a single product having a complicated shape can be manufactured by only one simple pressure compaction step.

In particular, the characteristics can be advantageous in the motor design field for manufacturing a 3D-shaped magnetic core, and a motor can be lightweight and produce high output power.

However, in accordance with a conventional method for manufacturing a soft magnetic composite, since a coating layer of magnetic powder is destroyed due to a high temperature in a sintering process, a pressure compaction process has to be used. Thus, a decrease in pore between particles and improvement of mechanical properties only through the pressure compaction process remains as relatively difficult problems.

United States Patent Application Publication No. US 2014/0232034 as prior art literature discloses a method for molding a powder mold product, in which raw material powder is packed into a cavity formed by a first punch and a die capable of being relatively shifted, a powder mold product being molded by the raw material powder in the cavity being pressed by the first punch and a second punch. The technology in the prior art discloses a preparing step of preparing the raw material powder; an applying step of interposing a mold assembly-use lubricant between an outer circumferential face of the first punch and an inner circumferential face of the die, the first punch and the die in this state being relatively shifted to apply the mold assembly-use lubricant to the inner circumferential face of the die; and a molding step of packing the raw material powder into the cavity surrounded by the first punch and the die to which the mold assembly-use lubricant has been applied, a powder mold product being molded by the raw material powder being pressed by the first punch and the second punch.

In addition, U.S. Pat. No. 9,318,254 discloses an inductor core made of a compressed soft magnetic powder material including: a base core portion having a first surface and an opposite second surface; an inner core portion extending from the first surface in a direction transverse to the first surface; and an outer core portion extending, in the direction transverse to the first surface, from the first surface to an end surface of the outer core portion, the outer core portion at least partly surrounding the inner core portion, thereby forming a space around the inner core portion for accommodating a winding, in which the first surface includes a recess for accommodating a connection portion of the winding, the recess extending at least a part of a distance between the inner core portion and the outer core portion, the outer core portion presents a slit extending from the end surface towards the recess, and the second surface comprises a first protrusion oppositely arranged to the recess.

### CITATION LIST

### Patent Literature

### Patent Literature 1

United States Patent Application Publication No. US 2014/0232034

### Patent Literature 2

U.S. Pat. No. 9,318,254

### SUMMARY OF INVENTION

### Technical Problem

Objects of the present invention to solve the problems described above are to increase density and to improve performance of a soft magnetic composite and, in order to embody the objects, powder is put in a die and pressed and ultrasonic vibration is applied to the die at the same time as pressing of the powder.

Technical objects to be achieved by the present invention are not limited to the technical objects mentioned above, and the following description enables other unmentioned technical objects to be clearly understood by a person of ordinary skill in the art to which the present invention belongs.

### Solution to Problem

According to a configuration of the present invention to achieve an object described above, there is provided an apparatus for manufacturing a soft magnetic composite using ultrasonic vibration, the apparatus including: a die that has a putting-in space inside an inner die surface, the putting-in space being an open space in which a powder material is put; a punch set that is inserted into the putting-in space and presses the powder material; an ultrasonic vibration applying unit including ultrasonic vibrators which are arranged along a circumference of an outer die surface of the die and are provided to come into contact with the die; a main body that is positioned below the die and is formed to slide around the die toward an outer circumference; and a control unit that controls a frequency of the ultrasonic vibrators depending on a degree of pressure of the punch set.

In an embodiment of the present invention, the punch set may include: an upper punch that is inserted into an upper part of the putting-in space and presses an upper part of the powder material; and a lower punch that is inserted into a lower part of the putting-in space and presses a lower part of the powder material.

In the embodiment of the present invention, the ultrasonic vibration applying unit may include a plurality of the ultrasonic vibrators which are arranged symmetrically to each other along the circumference of the outer surface of the die and apply vibration having equal amplitude to the die, and the outer surface of the die may be configured to have contact surfaces corresponding to the plurality of ultrasonic vibrators, the contact surfaces being flat portions which are brought into close contact with the ultrasonic vibrators.

In the embodiment of the present invention, each of the ultrasonic vibrators may include: a vibrator unit which comes into contact with the die and transmits ultrasonic vibration to the die; a transducer unit which receives a control signal of the control unit and controls an ultrasonic vibration frequency of the vibrator unit; and a support which is formed to surround a connection portion between the vibrator unit and the transducer unit and fixes the vibrator unit to the main body.

In the embodiment of the present invention, each of the ultrasonic vibrators may further include a support guide which enables a lower end of the support to move flexibly.

In the embodiment of the present invention, the support may be formed to surround only a lower part of the connection portion between the vibrator unit and the transducer unit.

In the embodiment of the present invention, each of the ultrasonic vibrators may have a thread at a circumference of the vibrator unit which is surrounded by the support, and a portion of the support which surrounds the vibrator unit has a thread intermeshing with the circumference of the vibrator unit surrounded by the support.

In the embodiment of the present invention, the main body may include: a first main body unit 410 which is coupled to lower parts of the die and the ultrasonic vibration applying unit; a second main body unit 420 which is formed below the first main body unit 410 separately from each other; and an elastic means 430 which is positioned between the first main body unit 410 and the second main body unit 420 and damps ultrasonic vibration applied to the die by the ultrasonic vibration applying unit and a reaction of the ultrasonic vibration.

In the embodiment of the present invention, the main body may further include a force sensor which measures ultrasonic vibration transmitted to the die and a reaction of the ultrasonic vibration and transmits a value obtained from the measurement to the control unit.

According to a configuration of the present invention to achieve another object described above, there is provided a method for manufacturing a soft magnetic composite using ultrasonic vibration, the method including: a step of putting a powder material in an open space inside a die; a step of pressing the powder material; a step of measuring pressure applied to the powder material; a step of transmitting ultrasonic vibration to an outer surface of the die by the ultrasonic vibrators; a step of reducing friction between an inner surface of the die and particles of the powder material by vibration of the die; and a step of increasing density of a soft magnetic composite.

According to a configuration of the present invention to achieve still another object described above, there is provided a soft magnetic composite manufactured using ultrasonic vibration by the apparatus for manufacturing a soft magnetic composite using ultrasonic vibration according to the above-described embodiment of the present invention.

In another embodiment of the present invention, the soft magnetic composite may be manufactured by the apparatus for manufacturing a soft magnetic composite using ultrasonic vibration, under conditions that input power is 6,000 W and pressure is 830 MPa, and may have a density range of 7.2 g/cm³ to 7.38 g/cm³.

### Advantageous Effects of Invention

The present invention according to the configuration described above has the following effects. At least one ultrasonic vibrator is provided around a die, and ultrasonic vibration is applied to the die so that cohesion of powder is increased when the power in an inner space of the die is compressed.

In addition, a pore ratio of powder particles is decreased through a process of applying the ultrasonic vibration, and a compact of a soft magnetic composite having target density of 7.38 g/cm³ can be formed.

In addition, a structure in which ultrasonic vibrators are arranged symmetrically to each other and transmit an ultrasonic wave enables a product having a homogeneous property to be molded, whichever shape the product has. Further, a lower end of an ultrasonic support which supports each of the ultrasonic vibrators can move flexibly, and thereby it is possible to increase a degree of freedom and more improve transmission of the ultrasonic wave.

In addition, various design variables are directly defined to derive relationships therebetween, and thereby it is possible to easily derive target density, a usable pressure value, a necessary input power value and to configure a manufacturing apparatus and a control system depending on various requested values.

The effects of the present invention are construed not to be limited to the above-mentioned effects but to include every effect that can be derived from the configurations of the invention described in Description of Embodiments or Claims of the present invention.

### BRIEF DESCRIPTION OF DRAWINGS

FIG. 1 is a cross-sectional view of an existing apparatus for manufacturing a soft magnetic composite without using ultrasonic vibration.

FIG. 2 is a schematic front view according to an embodiment of an apparatus for manufacturing a soft magnetic composite using ultrasonic vibration of the present invention.

FIG. 3 is a perspective view according to the embodiment of the apparatus for manufacturing a soft magnetic composite using ultrasonic vibration of the present invention.

FIG. 4 is a graph illustrating a relationship between a resonant frequency and a diameter of a die according to the embodiment of the apparatus for manufacturing a soft magnetic composite using ultrasonic vibration of the present invention.

FIG. 5 is a graph illustrating a relationship between the resonance frequency, the diameter of the die, and a thickness of the die according to the embodiment of the apparatus for manufacturing a soft magnetic composite using ultrasonic vibration of the present invention.

FIG. 6 is a graph illustrating a relationship between the resonance frequency, the diameter of the die, a width of a flat side surface of the die according to the embodiment of the apparatus for manufacturing a soft magnetic composite using ultrasonic vibration of the present invention.

FIG. 7 is a graph illustrating a relationship between a vibration amplitude, an input voltage, and the number of ultrasonic vibrators according to the embodiment of the apparatus for manufacturing a soft magnetic composite using ultrasonic vibration of the present invention.

FIG. 8 is a graph illustrating a relationship between pressure and density obtained by comparing soft magnetic composites depending on whether or not ultrasonic vibration is applied.

FIG. 9 is a graph illustrating a relationship between the amount of lubricant and density increase obtained by comparing soft magnetic composites depending on whether or not ultrasonic vibration is applied.

FIG. 10 is a cross-sectional view illustrating particles and pores according to a conventional compaction method and a pressure compaction method using ultrasonic vibration.

FIG. 11 is a three-dimensional graph illustrating a correlation between density and input power due to a pressure change.

FIG. 12 is a perspective view of the ultrasonic vibrator according to the embodiment of the apparatus for manufacturing a soft magnetic composite using ultrasonic vibration of the present invention.

FIG. 13 is a perspective view of the ultrasonic vibrator according to the embodiment of the apparatus for manufacturing a soft magnetic composite using ultrasonic vibration of the present invention.

FIG. 14 is a flowchart of a method for manufacturing a soft magnetic composite using ultrasonic vibration of the present invention.

### DESCIPRION OF PREFERRED EMBODIMENT

A preferred embodiment according to the present invention includes: a die that has a putting-in space inside an inner die surface, the putting-in space being an open space in which a powder material is put; a punch set that is inserted into the putting-in space and presses the powder material; an ultrasonic vibration applying unit including ultrasonic vibrators which are arranged along a circumference of an outer die surface of the die and are provided to come into contact with the die; a main body that is positioned below the die and is formed to slide around the die toward an outer circumference; and a control unit that controls a frequency of the ultrasonic vibrators depending on a degree of pressure of the punch set.

### Description of Embodiments

Hereinafter, the present invention will be described with reference to the accompanying drawings. However, the present invention can be realized as various different embodiments, thus not being limited to embodiments described here. Besides, a part irrelevant to the description is omitted from the drawings in order to clearly describe the present invention, and similar reference signs are assigned to similar parts through the entire specification.

In the entire specification, a case where a certain part “is connected to (accesses, is in contact with, or is coupled to)” another part includes not only a case where the parts are “directly connected” to each other, but also a case where the parts are “indirectly connected” to each other with another member interposed therebetween. In addition, a case where a certain part “includes” a certain configurational element means that another configurational element is not excluded but can be further included, unless specifically described otherwise.

Terms used in this specification are only used to describe a specific embodiment and are not intentionally used to limit the present invention thereto. A word having a singular form also has a meaning of its plural form, unless obviously implied otherwise in context. In this specification, words such as “to include” or “to have” are construed to specify that a feature, a number, a step, an operation, a configurational element, a member, or a combination thereof described in the specification is present and not to exclude presence or a possibility of addition of one or more additional features, numbers, steps, operations, configurational elements, members, or combinations thereof in advance.

Hereinafter, embodiments of the present invention will be described in detail with reference to the accompanying drawings.

In general, a powder material can have high density by using a sintering process of developing cohesion between powder particles at a high temperature. However, since an insulation coating of soft magnetic composite (SMC) powder is destroyed due to the high temperature, a problem arises in that the SMC cannot be used in the sintering process, and thus only a pressure compaction (compression) method can be performed on the SMC.

Incidentally, the pressure compaction method can cause pores to be formed in a compressing process of the SMC, and thus magnetic and mechanical properties can be degraded. Hence, in order to overcome shortcomings of low density, a method of using very high compression pressure is considered in the related art.

However, as the compression pressure increases, a service life of a die decreases, and friction between the die and powder increases. Hence, a compressed SMC test specimen is difficult to remove, and thus in order to obtain higher magnetic and mechanical properties, a newer compression method needs to be provided.

In this respect, various ultrasonic compression methods have been tested; however, little information on quantitative analysis of effects of an ultrasonic wave is known, and a design guideline for ultrasonic compression is not known.

In this respect, the present invention is provided to establish a method for applying ultrasonic vibration to a die in an SMC compaction process and newly discloses a method for manufacturing a soft magnetic composite using ultrasonic vibration through the method for applying ultrasonic vibration to a die. In this respect, the present invention has an advantage in that a highly efficient electric motor can be developed at a low production cost by using the ultrasonic compression method.

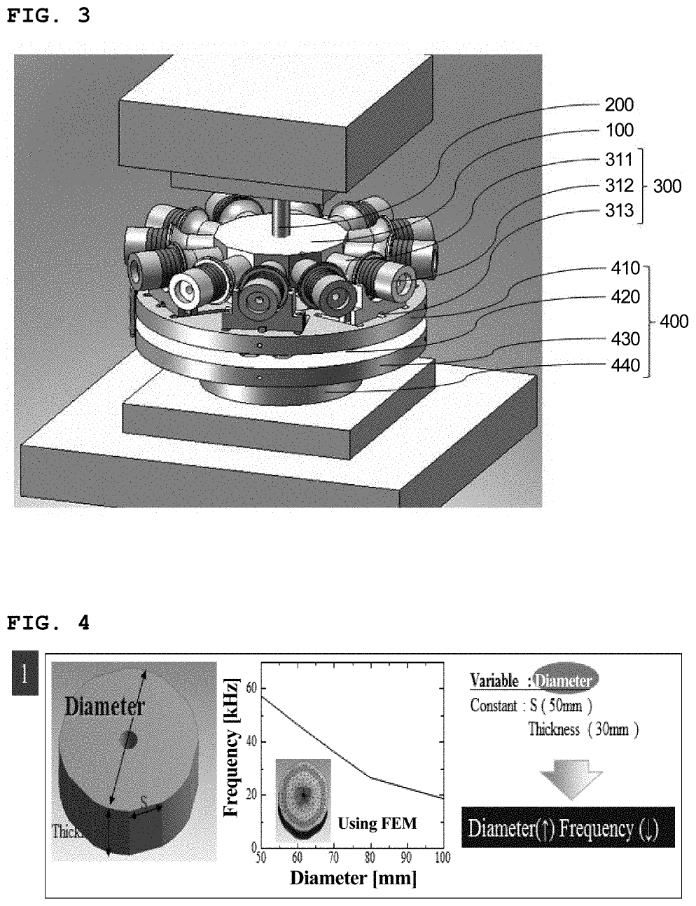

FIGS. 2 and 3 illustrate a front penetrating view and a perspective view of an apparatus for manufacturing a soft magnetic composite using ultrasonic vibration according to an embodiment of the present invention, respectively.

The apparatus for manufacturing a soft magnetic composite using ultrasonic vibration according to an embodiment of the present invention includes: a die 100 that has a putting-in space 110 as a space in which a powder material is put; a punch set 200 that is inserted into the putting-in space 110 and presses the powder material; an ultrasonic vibration applying unit 300 including ultrasonic vibrators 310 which are arranged along a circumference of an outer die surface 130 of the die 100 and are provided to come into contact with the die 100; a main body 400 that is coupled to lower parts of the die 100 and the ultrasonic vibrators 310 and is formed to slide around the die 100 toward an outer circumference; and a control unit 500 that controls a frequency of the ultrasonic vibration applying unit 300 corresponding to a degree of pressure of the punch set 200.

A conventional system is a one-way action method for applying pressure to one side of the powder material, whereas the apparatus for manufacturing a soft magnetic composite using ultrasonic vibration according to an embodiment of the present invention can be applied to a dual action method in which the powder material can be pressed in two directions.

In this respect, the punch set 200 includes: an upper punch 210 that is inserted into an upper part of the putting-in space 110 and presses an upper part of the powder material; and a lower punch 220 that is inserted into a lower part of the putting-in space 110 and presses a lower part of the powder material.

The ultrasonic vibration applying unit 300 includes a plurality of ultrasonic vibrators 310 which are arranged symmetrically to each other along the circumference of the die 100 and apply ultrasonic vibration having equal amplitude to a side wall of the die 100.

In this case, the outer die surface 130 of the die 100 is configured to have contact surfaces 131 corresponding to the plurality of ultrasonic vibrators 310, the contact surfaces being flat side surfaces which are brought into close contact with the plurality of ultrasonic vibrators 310.

The ultrasonic vibrator 310 includes: a vibrator unit 311 which comes into contact with the die 100 and transmits ultrasonic vibration to the die 100; a transducer unit 312 which receives a control signal of the control unit 500 and controls an ultrasonic vibration frequency of the vibrator unit 311; and a support 313 which is formed to surround a connection portion between the vibrator unit 311 and the transducer unit 312 and fixes the vibrator unit 311 to the main body 400.

A basic mechanism of the apparatus for manufacturing a soft magnetic composite using ultrasonic vibration of the present invention is as follows.

In the first step, the punch set 200 applies pressure to an SMC test specimen which is the powder material in the putting-in space 110 inside the die 100. Here, density of a produced soft magnetic composite is determined by an equilibrium state (equilibrium force and resistance)

In the second step, the ultrasonic vibration applying unit applies ultrasonic vibration to the die 100 in a state where pressure is applied. Vibration of the die 100 reduces friction between an inner wall of the die 100 and powder material particles, and thus density of the SMC can be improved.

Evaluation of design and basic performance of a simplified ultrasonic molding system of the apparatus for manufacturing a soft magnetic composite using ultrasonic vibration according to an embodiment of the present invention is described.

The die 100 is designed to have a resonant frequency equal to a resonant frequency of the ultrasonic vibration applying unit 300. In this respect, in order to design a simplified ultrasonic molding model, an experiment is conducted by selecting a diameter D and a thickness T of the die 100 and a width S of the contact surface 131 as main parameters.

FIGS. 4 to 6 illustrate experiment graphs of a relationship between the resonant frequency and the diameter D and the thickness T of the die 100 and the width S of the contact surface 131 as three variables, using a microelement method.

As illustrated in FIG. 4, in the first step, a relationship between the resonant frequency and the diameter D of the die 100 of which the thickness T is 30 mm and the width of the contact surface 131 is 50 mm is checked. The experimental result graph in FIG. 4 clearly shows that the diameter D of the die 100 has a large effect on the resonant frequency.

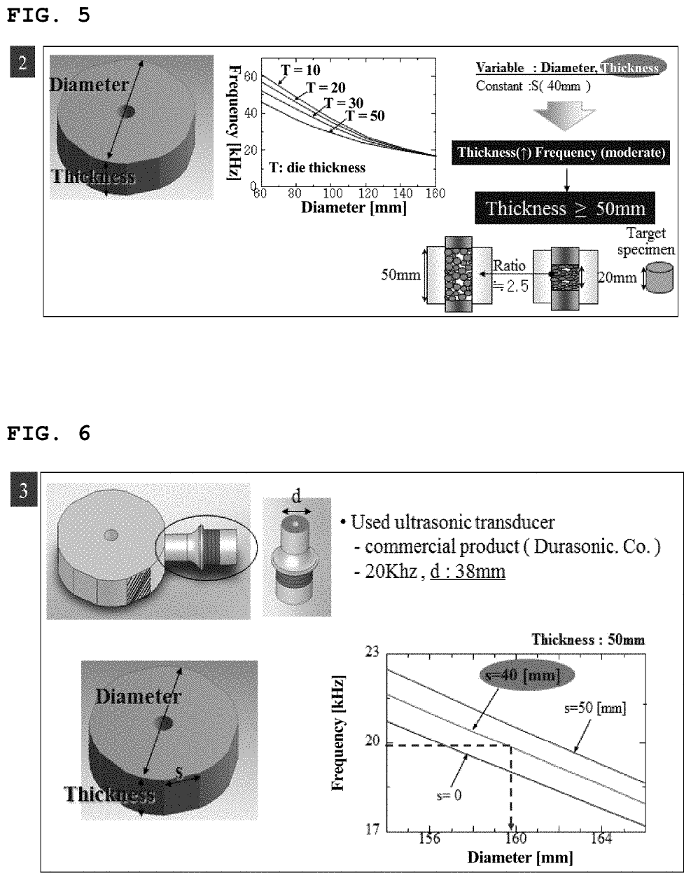

As illustrated in FIG. 5, in the second step, a relationship between the diameter D and the thickness T of the die 100 is checked. The experimental result graph in FIG. 5 clearly shows that, when the diameter D of the die 100 is larger than 140 mm, the thickness T of the die 100 has a small effect on the resonant frequency.

As illustrated in FIG. 6, in the third step, a relationship between the resonant frequency and the width S of the contact surface 131 of the die 100 having a thickness T of 50 mm is checked. Since a mass with respect to vibration is reduced by cutting, a flattening cut increases the resonant frequency.

Based on the above-described experimental data, the diameter D, the thickness T, and the width S of the contact surface 131 can be determined such that the die 100 has the resonant frequency equal to vibration of the ultrasonic vibration applying unit 300.

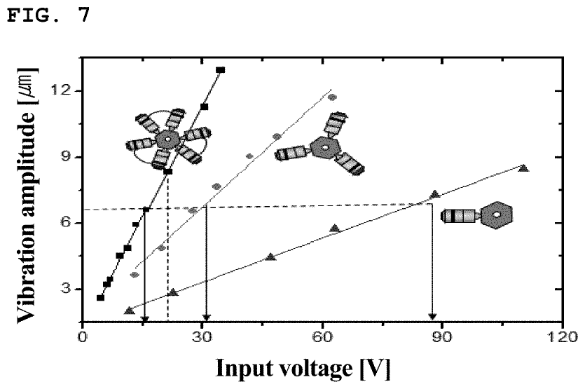

FIG. 7 illustrates an experimental result graph of an effect of input power to the apparatus for manufacturing a soft magnetic composite using ultrasonic vibration of the present invention on a vibration amplitude.

As illustrated in the graph of FIG. 7, the vibration amplitude increases, at the same input voltage, as the number of ultrasonic vibrators 310 increases. When one ultrasonic vibrator 310 is used, a vibration amplitude of about 7 μm is obtained by applying an input voltage of 90 V.

On the other hand, when six ultrasonic vibrators 310 is used to achieve vibration compression, the vibration amplitude of about 7 μm is obtained by applying an input voltage of 15 V. This indicates that an input voltage for obtaining the same vibration amplitude is inversely proportional to the number of ultrasonic vibrators 310.

A main parameter for determining a fundamental resonant frequency in an extending mode is the diameter D of the die 100, and the thickness T of the die 100 does not have a large effect on the resonant frequency, whereas a linear relationship between a force factor and the number of ultrasonic vibrators 310 is derived.

Hereinafter, technical effects of the apparatus for manufacturing a soft magnetic composite using ultrasonic vibration according to the embodiment of the present invention are described, compared to a conventional technology.

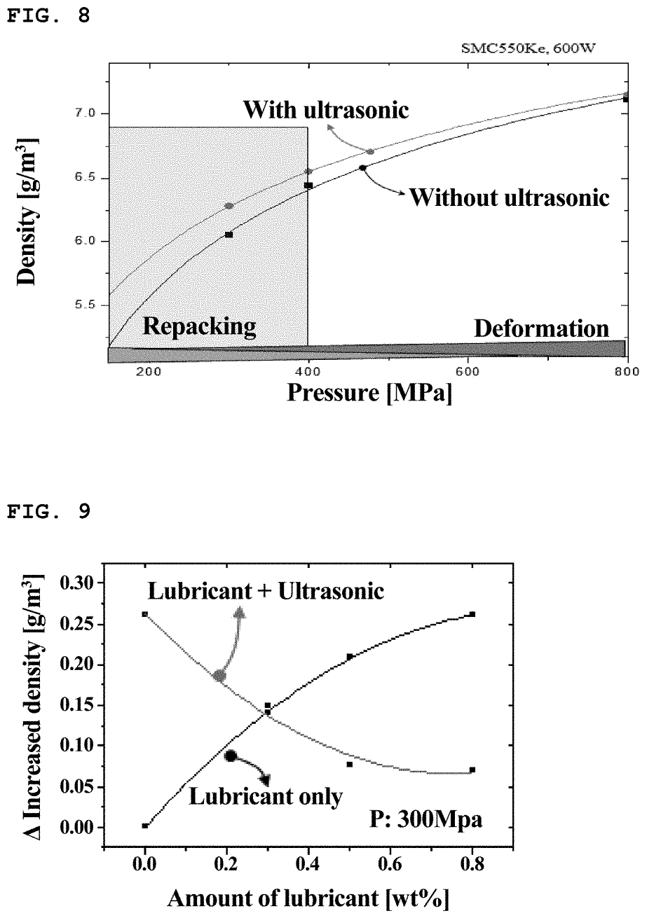

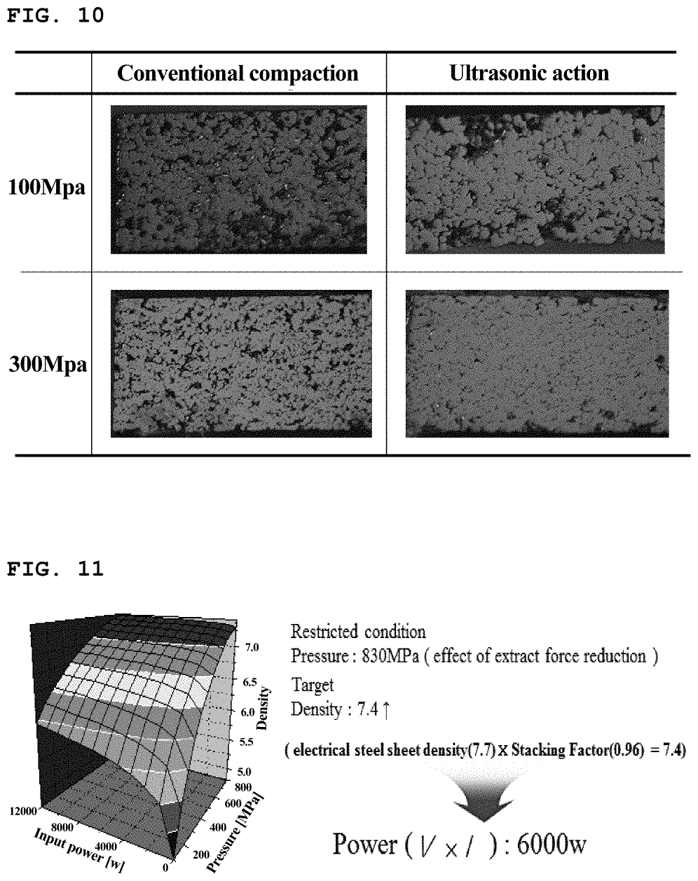

FIG. 8 illustrates a comparison between density graphs of the SMC obtained in a state with the ultrasonic vibration and a state without the ultrasonic vibration. FIG. 9 illustrates a comparison between density increase graphs of the SMC obtained in a case of applying a lubricant and a case of applying the lubricant and the ultrasonic vibration.

FIG. 10 illustrates results of analysis of pores between particles after compression in the state with the ultrasonic vibration and the state without the ultrasonic vibration, through a microscope.

A general compressing process of the powder material has the following mechanism. In the first step of compression, particles are compressed and slip to be rearranged under pressure without deformation of powder, and this step is referred to as ‘repacking’ in which density increases. In the second step, particles of powder start to be deformed due to high pressure, and this step is referred to as ‘deformation’ and is a step of increasing density.

As illustrated in FIG. 8, when the apparatus for manufacturing a soft magnetic composite using ultrasonic vibration according to the embodiment of the present invention is applied, the density is clearly increased due to the application of the ultrasonic vibration, compared to the compression result in the state without ultrasonic vibration.

In particular, a density difference from the compression result is relatively larger in a ‘repacking’ region than in a ‘deformation’ region, and this indicates that effects of the ultrasonic vibration are relatively large in a ‘repacking’ step.

The SMC powder is compressed with various amounts of lubricant under pressure of 300 MPa regardless of whether or not the ultrasonic vibration is applied. Here, as the amount of lubricant used increases, the density increases due to a slip increase effect in a conventional compressing process without ultrasonic vibration. As illustrated in FIG. 9, an increase in density by 0.29 g/cm³ or larger is measured due to a use of lubricant by 0.8 wt %.

On the other hand, when the ultrasonic vibration is applied, the density is increased very largely even though the powder is not lubricated, and the density is largely increased with use of the lubricant. This is because the ultrasonic vibration can improve a slip effect in the repacking step in the same way as the lubricant.

The experimental result illustrated in FIG. 10 shows that a porous compact is obtained by a conventional processing method without the ultrasonic vibration in which more pores are formed than the method using the ultrasonic vibration according to the embodiment of the present invention.

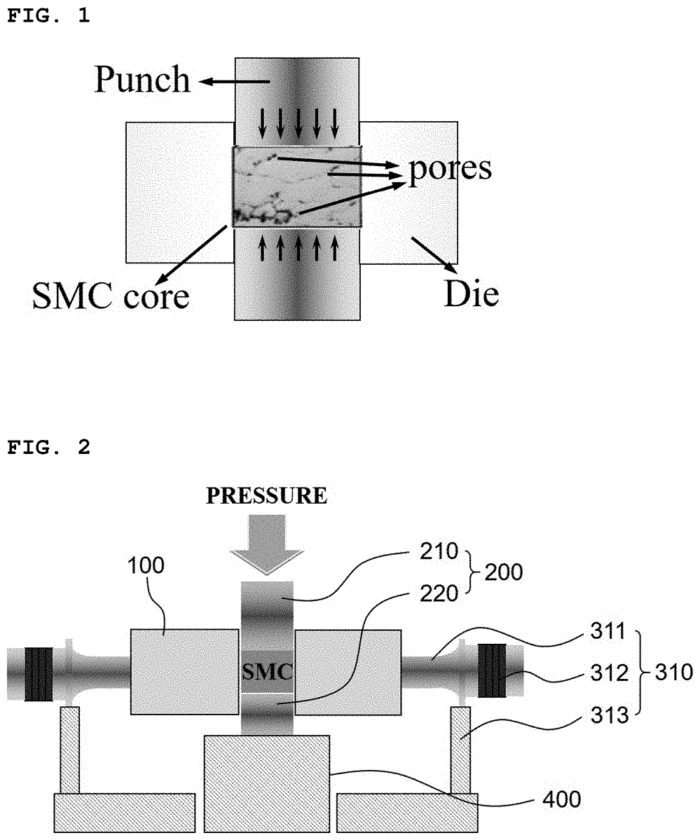

As illustrated in FIG. 1, the apparatus for manufacturing a soft magnetic composite using ultrasonic vibration according to an embodiment of the present invention can be configured to damp vibration which can be generated in the die 100 and a reaction of the vibration.

In this respect, the main body 400 includes: a first main body unit 410 which is coupled to lower parts of the die 100 and the ultrasonic vibration applying unit 300; a second main body unit 420 which is formed below the first main body unit 410 separately from each other; and an elastic means 430 which is positioned between the first main body unit 410 and the second main body unit 420 and damps the ultrasonic vibration applied to the die 100 by the ultrasonic vibration applying unit 300 and a reaction of the ultrasonic vibration.

In addition, the main body 400 according to the embodiment of the present invention further includes a force sensor 440 which measures ultrasonic vibration transmitted to the die 100 and a reaction of the ultrasonic vibration and transmits a value obtained from the measurement to the control unit 500.

The ultrasonic vibrator 310 of the present invention has the following embodiment in order to efficiently transmit an ultrasonic wave to the powder material.

As illustrated in FIG. 12, the support 313 according to the embodiment of the present invention is formed to surround only a lower part of the connection portion between the vibrator unit 311 and the transducer unit 312.

This enables the vibrator unit 311 of the present invention to more flexibly move such that a degree of freedom can be increased and transmission of the ultrasonic wave can be improved.

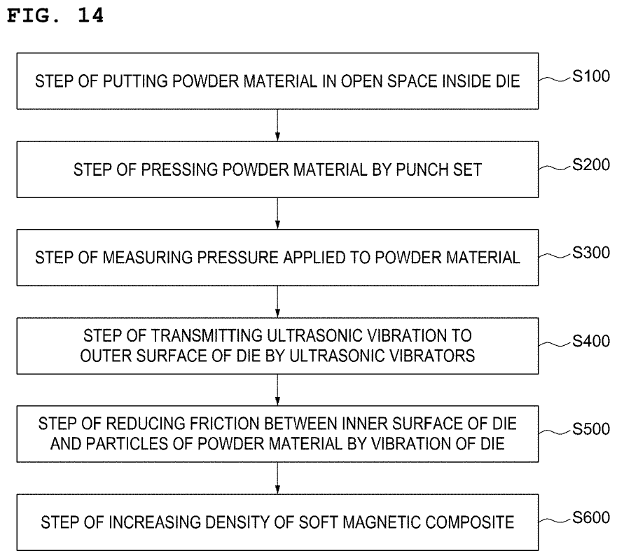

In addition, as illustrated in FIG. 13, the ultrasonic vibrator 310 is a free-moving type and further includes a support guide 314 which enables a lower end of the support 313 to move flexibly. In this respect, it is possible to obtain higher density and maintain a stable structure when the powder material is compressed, compared to a case where the ultrasonic vibrator 310 is a fixed type.

The ultrasonic vibrator 310 according to the embodiment of the present invention has a positive or negative thread at a circumference of the vibrator unit 311 which is surrounded by the support 313, and a portion of the support 313 which surrounds the vibrator unit has a negative or positive thread intermeshing with the circumference of the vibrator unit 311 surrounded by the support.

In this respect, the vibrator unit 311 and the support 313 have a high coupling force, and a coupled portion can be flexibly adjusted.

The plurality of ultrasonic vibrators 310 according to the embodiment of the present invention are used; however, there is no predetermined design guideline for determining the number of ultrasonic vibrators 310. Thus, the present invention provides a method for determining the appropriate number of ultrasonic vibrators 310 based on simulated input power and impedance.

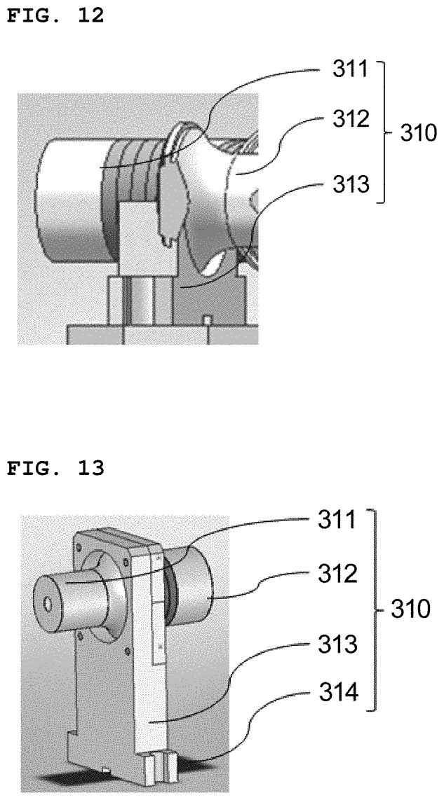

FIG. 11 is a three-dimensional graph illustrating a correlation between the density and input power due to a pressure change. The input power required when target density is 7.4 g/cm³ and usable pressure is 830 MPa will be described hereinafter.

As illustrated in FIG. 11, when the input power is increased at specific pressure, the density is rapidly increased. However, when the input power is lower than 4,000 W, the rapid increase of the density is gradually reduced due to saturation.

As a result, a condition required to obtain the target density is not only the input power of 6,000 W but also the pressure of 830 Mpa. In addition, a limit voltage of an amplifier is 200 V, and thus impedance is about 1.8 Ω.

A total of 12 or more ultrasonic vibrators 310 are required to satisfy the total impedance of 1.8 Ω. As a result, in the embodiment of the present invention for supplying the input power of 6,000 W to a system, 12 ultrasonic vibrators 310 are designed and provided.

Another technical characteristic of the present invention is a method for manufacturing a soft magnetic composite by using the apparatus for manufacturing a soft magnetic composite using ultrasonic vibration according to the above-described embodiment of the present invention.

More specifically, the method for manufacturing a soft magnetic composite according to another embodiment of the present invention includes: Step S100 of putting the powder material in the open space inside the die 100; Step S200 of pressing the powder material; Step S300 of measuring pressure applied to the powder material; Step S400 of transmitting ultrasonic vibration to the outer die surface 130 of the die 100 by the ultrasonic vibrators 310; Step S500 of reducing friction between the die inner surface 120 of the die 100 and particles of the powder material by vibration of the die 100; and Step S600 of increasing density of a soft magnetic composite.

In addition, still another technical characteristic of the present invention is a soft magnetic composite manufactured by the apparatus and the method for manufacturing a soft magnetic composite using ultrasonic vibration according to the above-described embodiments of the present invention.

As a result of a comparison of compressibility of the SMC powder by tests in accordance with the method described above, when the ultrasonic vibration is used by applying the embodiment of the present invention to the compressing process, an increase of density by 0.18 g/cm³ is achieved, compared to a conventional method. Finally, the high final density of 7.38 g/cm³ can be obtained by using a prototype system.

The description of the present invention described above is provided as an example, and a person of ordinary skill in the art to which the present invention belongs can understand that it is possible to easily modify the present invention to another embodiment without changing the technical idea or an essential feature of the present invention. Therefore, the embodiments described above need to be understood as exemplified embodiments and not as embodiments to limit the present invention in every aspect. For example, configurational elements described in a single form can be realized in a distributed manner. Similarly, the configurational elements described in the distributed manner can be realized in a combined manner.

The scope of the present invention needs to be represented by the claims to be described below, and meaning and the scope of the claims and every modification or modified embodiment derived from an equivalent concept of the claims need to be construed to be included in the scope of the present invention.

### REFERENCE SIGNS LIST

100 Die

110 Putting-in Space

120 Inner Die Surface

130 Outer Die Surface

131 Contact Surface

200 Punch Set

210 Upper Punch

220 Lower Punch

300 Ultrasonic Vibration Applying Unit

310 Ultrasonic Vibrator

311 Vibrator Unit

312 Transducer Unit

313 Support

314 Support Guide

400 Main Body

410 First Main Body Unit

420 Second Main Body Unit

430 Elastic Means

440 Force Sensor

500 Control Unit

1. An apparatus for manufacturing a soft magnetic composite using ultrasonic vibration, comprising:
a die that has a putting-in space inside an inner die surface, the putting-in space being an open space in which a powder material is put;
a punch set that is inserted into the putting-in space and presses the powder material;
an ultrasonic vibration applying unit including ultrasonic vibrators which are arranged along a circumference of an outer die surface of the die and are provided to come into contact with the die;
a main body that is positioned below the die and is formed to slide around the die toward an outer circumference; and
a control unit that controls a frequency of the ultrasonic vibrators depending on a degree of pressure of the punch set.

2. The apparatus for manufacturing a soft magnetic composite using ultrasonic vibration according to claim 1,
wherein the punch set includes:
an upper punch that is inserted into an upper part of the putting-in space and presses an upper part of the powder material; and
a lower punch that is inserted into a lower part of the putting-in space and presses a lower part of the powder material.

3. The apparatus for manufacturing a soft magnetic composite using ultrasonic vibration according to claim 1,
wherein the ultrasonic vibration applying unit includes a plurality of the ultrasonic vibrators which are arranged symmetrically to each other along the circumference of the outer surface of the die and apply vibration having equal amplitude to the die, and
wherein the outer surface of the die is configured to have contact surfaces corresponding to the plurality of ultrasonic vibrators, the contact surfaces being flat portions which are brought into close contact with the ultrasonic vibrators.

4. The apparatus for manufacturing a soft magnetic composite using ultrasonic vibration according to claim 1,
wherein each of the ultrasonic vibrators includes:
a vibrator unit which comes into contact with the die and transmits ultrasonic vibration to the die;
a transducer unit which receives a control signal of the control unit and controls an ultrasonic vibration frequency of the vibrator unit; and
a support which is formed to surround a connection portion between the vibrator unit and the transducer unit and fixes the vibrator unit to the main body.

5. The apparatus for manufacturing a soft magnetic composite using ultrasonic vibration according to claim 4,
wherein each of the ultrasonic vibrators further includes a support guide which enables a lower end of the support to move flexibly.

6. The apparatus for manufacturing a soft magnetic composite using ultrasonic vibration according to claim 4,
wherein the support is formed to surround only a lower part of the connection portion between the vibrator unit and the transducer unit.

7. The apparatus for manufacturing a soft magnetic composite using ultrasonic vibration according to claim 4,
wherein each of the ultrasonic vibrators has
a thread at a circumference of the vibrator unit which is surrounded by the support has a thread, and
a portion of the support which surrounds the vibrator unit has a thread intermeshing with the circumference of the vibrator unit surrounded by the support.

8. The apparatus for manufacturing a soft magnetic composite using ultrasonic vibration according to claim 1,
wherein the main body includes:
a first main body unit which is coupled to lower parts of the die and the ultrasonic vibration applying unit;
a second main body unit which is formed separately below the first main body unit separately from each other; and
an elastic means which is positioned between the first main body unit and the second main body unit and damps ultrasonic vibration applied to the die by the ultrasonic vibration applying unit and a reaction of the ultrasonic vibration.

9. The apparatus for manufacturing a soft magnetic composite using ultrasonic vibration according to claim 1,
wherein the main body further includes a force sensor which measures ultrasonic vibration transmitted to the die and a reaction of the ultrasonic vibration and transmits a value obtained from the measurement to the control unit.

10. A method for manufacturing a soft magnetic composite using ultrasonic vibration, comprising:
a step of putting a powder material in an open space inside a die;
a step of pressing the powder material by a punch set;
a step of measuring pressure applied to the powder material;
a step of transmitting ultrasonic vibration to an outer surface of the die by the ultrasonic vibrators;
a step of reducing friction between an inner surface of the die and particles of the powder material by vibration of the die; and
a step of increasing density of a soft magnetic composite.

11. A soft magnetic composite manufactured using ultrasonic vibration by the apparatus for manufacturing a soft magnetic composite using ultrasonic vibration according to claim 1.

12. The soft magnetic composite manufactured using ultrasonic vibration according to claim 11,
wherein the soft magnetic composite is manufactured by the apparatus for manufacturing a soft magnetic composite using ultrasonic vibration under conditions that input power is 6,000 W and pressure is 830 MPa, and has a density range of 7.2 g/cm³ to 7.38 g/cm³.
